(19) United States
(12) Patent Application Publication
(10) Pub. No.: US 2011/0121974 A1
(43) Pub. Date: May 26, 2011

(54) REAL-TIME METHOD AND SYSTEM FOR MONITORING HYGIENE COMPLIANCE WITHIN A TRACKING ENVIRONMENT

(75) Inventors: Henry J. Tenarvitz, Suttons Bay, MI (US); Robert Wiser, Grawn, MI (US)

(73) Assignee: VERSUS TECHNOLOGY, INC., Traverse City, MI (US)

(21) Appl. No.: 12/622,930

(22) Filed: Nov. 20, 2009

(51) Int. Cl. G08B 23/00; G06K 7/01

(52) U.S. Cl. 340/573.1; 340/10.1

(57) ABSTRACT

A real-time method and system are provided for monitoring hygiene compliance within a tracking environment provided by real-time tracking apparatus. Auto-ID personnel tags are associated with personnel whose hygiene compliance is desired to track locations of the personnel within the environment. Each of the personnel tags is capable of transmitting a wireless signal including ID information unique to its associated personnel tag. Personnel location information is generated based on the locations of the personnel tags within the environment. The method includes associating an auto-ID dispenser tag with each cleaning agent dispenser located within the tracking environment. Each of the dispenser tags is capable of transmitting a wireless signal including ID information. The method further includes sensing a state change which indicates activation of a particular dispenser. The method still further includes scanning a region about the activated dispenser for a first period of time in response to the state change to receive a wireless signal including its associated ID information transmitted by a personnel tag detected within the region. The method further includes utilizing the dispenser tag associated with the activated dispenser to transmit at least one wireless signal including information which identifies the detected personnel tag. The method still further includes assigning a status of hygiene compliant to the person associated with the detected personnel tag based on the signal transmitted by the dispenser tag.

### BACKGROUND OF THE INVENTION

1. Field of the Invention

This invention relates to real-time methods and systems for monitoring hygiene compliance within a tracking environment such as a clinical environment. At least one embodiment of the invention relates to methods and systems for determining hand hygiene status and providing event notifications within a tracking environment and tags and dispenser sensors for use therein. Such methods and systems are provided to sense and locate tag-wearing persons in front of a hand hygiene cleaning agent dispenser and associate actuation of the dispenser with the sensing event, providing notifications if the subject is deemed “non-compliant” based on time delays or interaction with another subject without having completed appropriate actuation of the dispenser within a tracking environment.

2. Background Art

U.S. Pat. No. 5,202,666 discloses an automated device used to remind employees to wash their hands after toileting. Sensors are worn on credit card sized badges and mounted in bathroom ceilings and attached to soap dispensers and sinks. When an employee enters the bathroom, the ceiling unit sensor activates a blinking light on the badge. The light is deactivated once the employee pumps the soap dispenser and stands in front of the sink for at least 15 seconds.

U.S. Pat. No. 5,945,910 discloses a hand washing and monitoring system that uses a sensor that signals the dispensation of a cleaning agent from a dispenser. A dual mode monitoring and reporting module includes an input element, an output element, a processor and memory. The module accepts data identifying an employee, receives a signal indicating dispensation of the cleaning agent and stores compliance data records.

U.S. Pat. No. 5,812,059 discloses a method and system for enhancing hygiene. An activating device is located outside a work area, a hand cleaning station is located near the work area, and a deactivating device is associated with the hand cleaning station. Upon leaving a food handling area, an indicator worn by a worker is activated when the worker is near the activating device. The indicator is deactivated only when it is determined that the worker has used the hand cleaning station.

Acquisition of infection by hospital patients is a serious healthcare problem. The Center for Disease Control, the World Health Organization and other health care organizations and agencies encourage healthcare workers to practice proper hand hygiene to reduce the transmission of pathogens via hands. Recommended procedures include the decontamination of the hands prior to direct patient contact, prior to invasive non-surgical procedures, prior to gloving, after contact with body fluid, mucous membranes, non-intact skin and wound dressings, intact skin and inanimate objects near patients. These procedures apply in hospital settings, doctor's offices, and anywhere where these personnel come into contact with patients. In some instances, application of an antimicrobial preparation to the hands is substituted for a hand washing. In any event, the goal is to reduce the microbe load on the healthcare provider's hands and prevent contamination of either the patients or healthcare providers.

Systems have been developed for monitoring the actions of workers. One such system includes badges worn by workers that are capable of transmitting or receiving information. As discussed in U.S. Pat. No. 6,236,317, workers are provided with badges that detect entry into an area that may be unsanitary and alert the workers to this fact. If a worker subsequently washes his hands or activates a disposable glove dispenser following such exposure, the alerting function of the badge is deactivated. If appropriate action is not taken by a worker, a violation is recorded by the badge or a system controller.

U.S. Pat. No. 6,882,278 describes another system that monitors compliance with recommended hand washing practices. The system includes a hand washing detector and an event detector such as a motion detector that detects an event such as a person entering or leaving a room. A control unit determines whether a person has washed his hands within a predetermined time period before entering the room.

U.S. Pat. Nos. 6,727,818 and 6,975,231 disclose other systems for promoting hygienic practices. The '818 patent discloses a system that tracks the movements of healthcare workers throughout the facility and within a patient's room. The healthcare workers are provided with badges that transmit ID information to sensors located in the hallways and rooms of the facility, which in turn transmit location information to a master station. ID information is also transmitted to wash sink sensors to indicate whether the healthcare worker has washed his hands. If the healthcare worker enters a patient contact zone in the patient's room without having complied with the required hand washing procedure, an alert is provided by the healthcare worker's badge and/or other alerting devices located on the patient's bed or in the patient's room. A time delay may be employed before a warning alert is provided so that an alert is not triggered by a healthcare worker who is only briefly in the patient contact zone.

The '231 patent discloses a system employing sets of detectors located just outside and within a patient's room. These detectors are actuated sequentially as a person enters the room and the time between their actuation is monitored in determining whether a person has entered the room. A determination is made as to whether the person has washed his hands within a predetermined period of time, and a warning signal is generated if the hands have not been washed within the set period.

As described above, it is difficult to determine the compliance rate of staff which have had interactions within infectious patients. One prior art system records these interactions so that late discovery of infections can be investigated, cross-contamination can be tracked and those who come into contact with known contamination can easily be recalled. A software package includes several reports, including a compliance report, that can be used to analyze the movement of people or items, thereby enabling one to track the spread of contagions. The compliance report demonstrates compliance with hygiene rules by displaying both successful and unsuccessful compliance. For instance, successful compliance can be represented by a staff member entering a designated “clean” zone (wash room) after entering a contaminated zone (patient room).

The following U.S. patent documents are related to the present invention: U.S. Pat. No. 6,392,546; U.S. Pat. No. 7,242,307; U.S. Pat. No. 7,423,533; 2008/0001763; 2008/0107636; 2008/0218351; and 2009/0091458.

The following U.S. patents are also related to the present invention: U.S. Pat. No. 4,868,859; U.S. Pat. No. 4,906,853; U.S. Pat. No. 5,017,794; U.S. Pat. No. 5,027,314; U.S. Pat. No. 5,027,383; U.S. Pat. No. 5,119,104; U.S. Pat. No. 5,131,019; U.S. Pat. No. 5,276,496; U.S. Pat. No. 5,355,222; U.S. Pat. No. 5,387,993; U.S. Pat. No. 5,548,637; U.S. Pat. No. 5,572,195; U.S. Pat. No. 6,104,295; U.S. Pat. No. 6,154,139; U.S. Pat. No. 6,462,656; U.S. Pat. No. 6,838,992; U.S. Pat. No. 7,286,057; U.S. Pat. No. 7,372,367; U.S. Pat. No. 7,375,640; U.S. Pat. No. 7,411,511; U.S. Pat. No. 7,443,305; U.S. Pat. No. 7,482,936; and U.S. Pat. No. 7,537,030.

Referring now to FIGS. 1 and 2, there is illustrated a prior art real-time tracking apparatus for locating subjects (i.e., persons and objects) in a tracking environment. In general, the apparatus is a combined infrared and radio frequency locating system which is adapted for use not only in medical applications, but also in non-medical applications. The apparatus is a fully automatic data collection system which provides real-time location information of personnel or equipment (i.e., subjects). Typically, information is collected using an in-ceiling and/or in-wall receiver network connected with common telephone-type wire to make accurate decisions and execute the appropriate responses. Typically, the components of the apparatus are relatively simple and modular. The apparatus and its components are specifically described in U.S. Pat. Nos. 6,154,139 and 6,838,992 which are hereby incorporated by reference in their entirety herein.

There are a number of drawbacks to current hand hygiene compliance systems, including: (1) lack of real-time location knowledge; (2) expensive specialized dispenser equipment; (3) deployment difficulty and expense to maintain; (4) specialized training requirements; and (5) an inability to leverage existing communication infrastructure.

### SUMMARY OF THE INVENTION

An object of the present invention is to provide an improved real-time method and system for monitoring hygiene compliance in a tracking environment such as a clinical environment.

Another object of at least one embodiment of the present invention is to provide a method and system to determine hand hygiene status that does not require expensive specialized dispenser equipment; is simple and inexpensive to deploy and maintain; requires no special training for clinical staff; and that leverages common, pre-existing communication infrastructure, when possible.

Yet another object of at least one embodiment of the present invention is to provide a method and system to determine hand hygiene status in a clinical environment and provide real-time compliance or non-compliance notification as well as historical analysis of recorded hygiene procedures through use of real-time locating apparatus.

In carrying out the above object and other objects of the present invention, a real-time method of monitoring hygiene compliance within a tracking environment provided by real-time tracking apparatus is provided. Auto-ID personnel tags are associated with personnel whose hygiene compliance is desired to track locations of the personnel within the environment. Each of the personnel tags is capable of transmitting a wireless signal including ID information unique to its associated personnel tag. Personnel location information is generated based on the locations of the personnel tags within the environment. The method includes associating an auto-ID dispenser tag with each cleaning agent dispenser located within the tracking environment. Each of the dispenser tags is capable of transmitting a wireless signal including ID information. The method further includes sensing a state change which indicates activation of a particular dispenser. The method still further includes scanning a region about the activated dispenser for a first period of time in response to the state change to receive a wireless signal including its associated ID information transmitted by a personnel tag detected within the region. The method further includes utilizing the dispenser tag associated with the activated dispenser to transmit at least one wireless signal including information which identifies the detected personnel tag. The method still further includes assigning a status of hygiene compliant to the person associated with the detected personnel tag based on the signal transmitted by the dispenser tag.

The environment may be a clinical environment and the personnel may be givers of care to patients. An auto-ID patient tag is associated with each patient to track locations of patients within the environment. Patient location information based on the locations of the patient tags within the environment are generated. The method may further include recording the caregiver and patient location information and the status of the caregivers.

The method may further include assigning a status of hygiene non-compliant to the person associated with the detected personnel tag when either the detected personnel tag enters a hygiene non-compliant zone or a second period of time elapses following activation of the dispenser.

The method may further include performing an action based on the status of the person.

The action may include an audio or video alert.

The alert may be a video alert comprising a text or graphical alert.

The step of scanning may include the step of scanning a delimited zone in front of the dispenser to detect the personnel tag.

The hygiene may be hand hygiene and the cleaning agent may be a hand cleaning agent.

The state change may be a switch state change.

The state change may indicate motion or vibration associated with activation of the dispenser.

Further in carrying out the above object and other objects of the present invention, a real-time system for monitoring hygiene compliance within a tracking environment provided by a real-time tracking apparatus is provided. Auto-ID personnel tags are associated with personnel whose hygiene compliance is desired to track locations of the personnel within the environment. Each of the personnel tags is capable of transmitting a wireless signal including ID information unique to its associated personnel tag. Personnel location information is generated based on the locations of the personnel tags within the environment. The system includes an auto-ID dispenser tag associated with each cleaning agent dispenser located within the tracking environment. Each of the dispenser tags being capable of transmitting a wireless signal including ID information. The system further includes a dispenser sensor configured to sense state change which indicates activation of a particular dispenser located within the tracking environment. The system still further includes a receiver associated with each of the sensors and configured to scan a region about the activated dispenser for a first period of time in response to the state change and to receive a wireless signal including its associated ID information transmitted by a personnel tag detected within the region. A dispenser tag associated with the activated dispenser transmits at least one wireless signal including information which identifies the detected personnel tag. The system still further includes apparatus configured to assign a status of hygiene complaint to the person associated with the detected personnel tag based on the signal transmitted by the dispenser tag.

The environment may be a clinical environment and the personnel may be givers of care to patients. An auto-ID patient tag is associated with each patient in the clinical environment to track locations of patients within the environment. Patient location information based on the locations of the patient tags within the environment may be generated. The caregiver and patient location information and the status of the caregiver may be recorded in a data repository.

The system may further include apparatus for assigning a status of hygiene non-compliant to the person associated with the detected personnel tag when either the detected personnel tag enters a hygiene non-compliant zone or a second period of time elapses following activation of the dispenser.

The system may further include apparatus configured to perform an action based on the status of the person.

The receiver may scan a delimited zone in front of the dispenser to detect the personnel tag.

The action may include an audio or video alert.

The alert may be a video alert comprising a text or graphical alert.

The state change may be a switch state change

The state change may indicate motion or vibration associated with activation of the dispenser.

The hygiene may be hand hygiene and the cleaning agent may be a hand cleaning agent.

Each of the dispenser tags may include a receiver so that each of the dispenser tags comprises a transceiver.

The above object and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a schematic overview diagram illustrating a prior art method and apparatus for locating subjects within a clinical environment;

FIG. 2 is a schematic block diagram specifically illustrating a prior art auto-ID tag useful with the method and apparatus of FIG. 1;

FIG. 3 is a diagram similar to the diagram of FIG. 1 but illustrating a method and system of at least one embodiment of the present invention;

FIG. 4 is a view, taken along lines A-A of FIG. 3, of an infrared receiver within a typical field of view;

FIG. 5 is a view, taken along lines B-B of FIG. 3, of an infrared receiver within a reduced field of view;

FIG. 6 is a diagram similar to the diagram of FIG. 2 but specifically illustrating an auto-ID dispenser tag useful with at least one embodiment of a method and system of the present invention;

FIG. 7 is a view of a typical report that can be generated by using at least one embodiment of the present invention;

FIG. 8 is a view of a possible text alert that can be generated and displayed using at least one embodiment of the present invention; and

FIG. 9 is a view of a dashboard type graphical indicator that can be generated and displayed using at least one embodiment of the present invention.

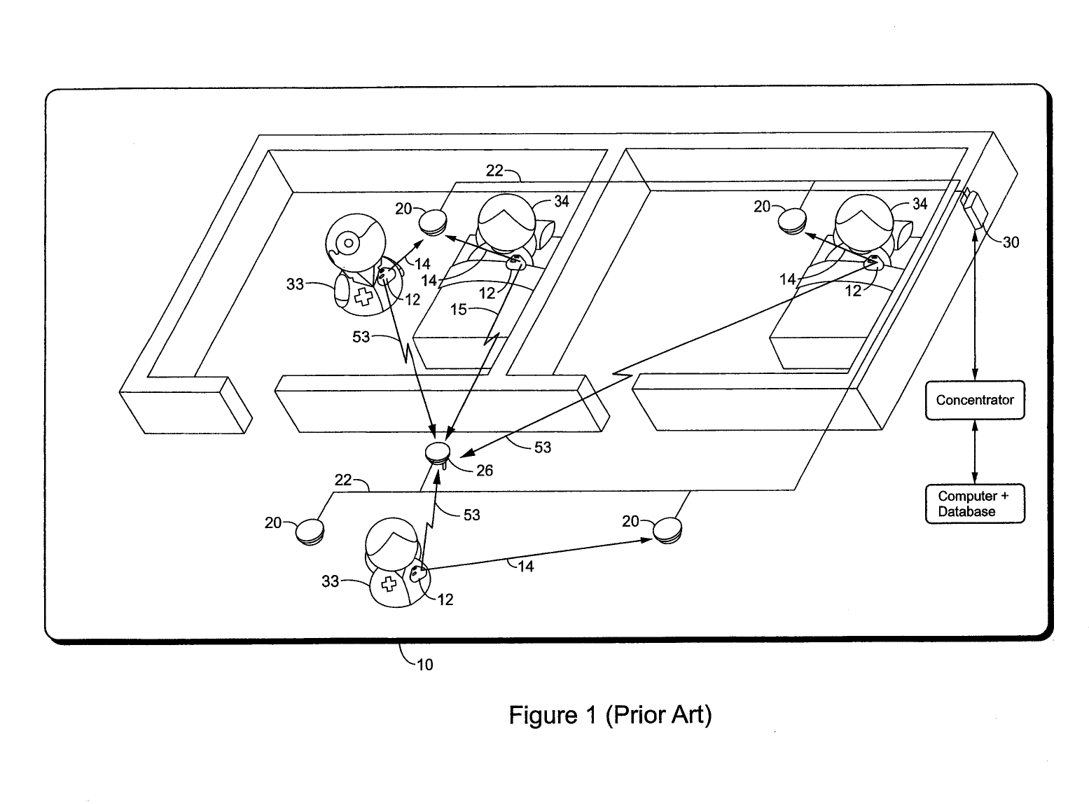

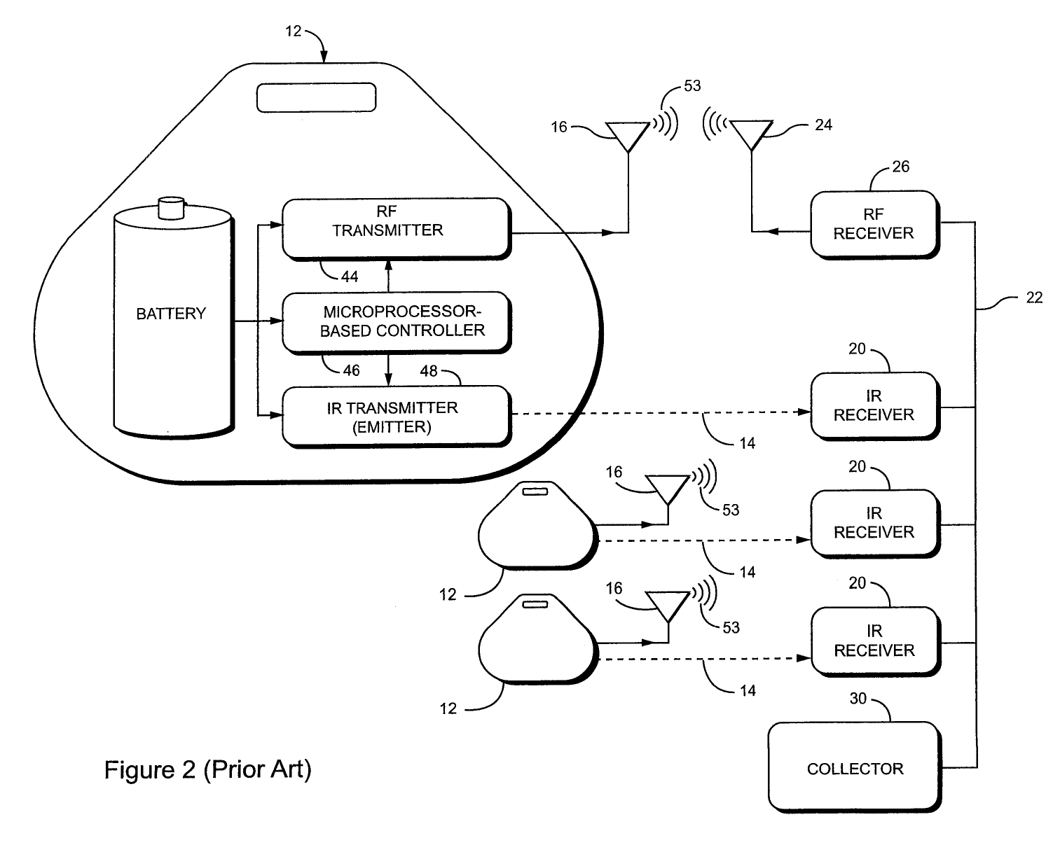

### DETAILED DESCRIPTION OF THE PREFERRED EMBODIMENT(S)

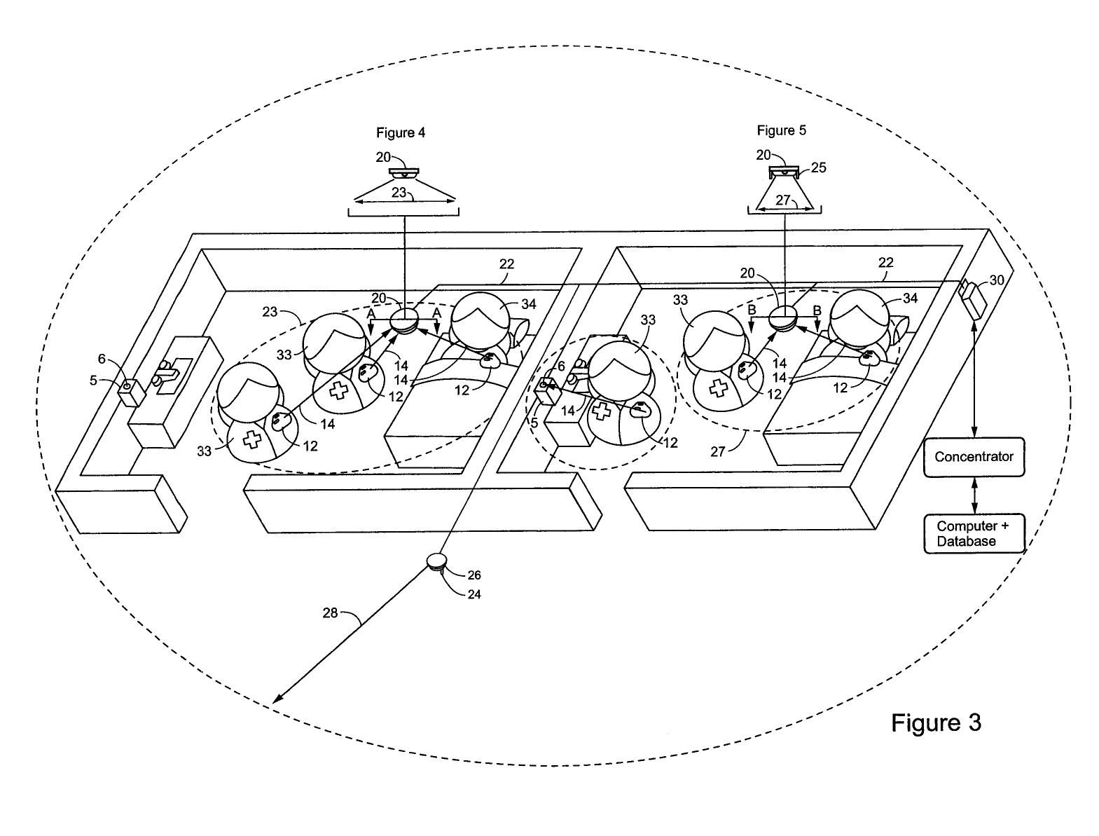

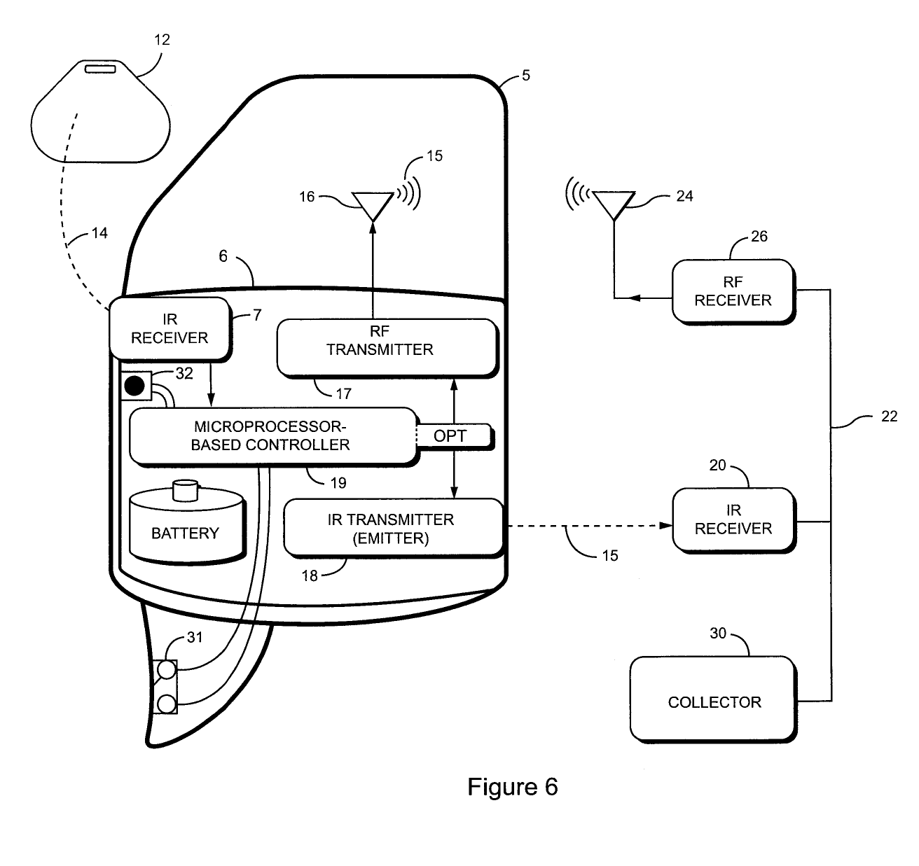

Referring now to the drawing figures, there is illustrated a real-time tracking system, generally indicated at 10, which may also be used to capture hand hygiene events as performed by subjects identified as caregivers and to determine compliant or non-compliant interactions of caregivers with subjects identified as patients. Referring specifically to FIGS. 3 and 6, the system 10 is comprised of tags 12 (worn by subjects or attached to objects) which emit infrared (i.e., IR) signals 14 which are captured by infrared receivers 20 common to the tracking system and a specialized transceiver 6 that upon activation of dispenser 5 reads an IR signal 14 from a caregiver badge, adds a data element which identifies the caregiver badge to its own identifying data element and transmits a qualified badge signal 15 which includes the two identifying data elements via an IR emitter 18 or RF transmitter 17. However, it is to be understood that the transducer 6 could transmit multiple signals to provide the necessary information.

Typically, the maximum effective line-of-sight range of such infrared signals 14 is about a twenty meter diameter 23 with the receiver of FIG. 4. To achieve higher granularity within the system 10, the infrared receiver 20 may have its field of view reduced to as little as a one meter diameter 27 by introducing a restrictor 25 in the IR sensor 20 (i.e., FIG. 5). The tags 12 may also transmit radio frequency (i.e., RF) signals 53 which are received by an RF receiver 26. The radio frequency signal 53 emitted by the antennas 16 are received by an antenna 24 of a radio frequency receiver 26 having a range of approximately forty meters 28 in all directions. Typically, information is collected using an in-ceiling and/or in-wall serial network 22 that terminates at the microprocessor-based collector 30.

The IR receiver 20 is stationary and its location is known. The dispenser 5 may or may not be stationary. Tags 12 are worn by mobile subjects and transmit unique IDs 14 which allow the tracking system 10 to associate unique subject identifiers (such as physician, nurse or patient) to each individual tag 12. With this association, when IR signals 14 are received by an IR receiver 20 or dispenser transceiver 6, the tracking system 10 identifies the tag(s) 12 (and hence the subject or subjects) relative to the location of the IR receiver. The tracking system 10 aggregates the unique IDs received from the tags 12 enabling the system 10 to identify when one or more unique IDs are present at a particular location (represented by an IR sensor 20). The tracking system 10 also calculates the amount of time that has passed since last receipt of each IR signal 14 at an IR sensor 20 or specialized transceiver 6.

Since it is important that certain tag-wearing subjects identified as givers of care (i.e., caregivers) to patients perform a hand cleansing event prior to interacting with other tag-wearing subjects identified as patients, the tracking system recognizes when a subject with a caregiver tag 18 activates the dispenser 5 to deliver hand cleaning agent. To accomplish this, an IR receiver 7 of the transceiver or tag 6 scans the area directly in front of the dispenser 5 when it is activated to detect an IR transmission 14 from the tag 12. The microprocessor-based controller 19 of the specialized transceiver 6 adds a data element which identifies the caregiver tag to its own identifying data element and transmits a modified badge signal 15 including the two identifying data elements via an IR emitter 18 or RF transmitter 17.

The specialized transceiver or badge 6 of each dispenser begins operating when it senses a state change in its trigger circuit. The state change may be indicated in a variety of ways as indicated in FIG. 6. The most straightforward activation method is to install a micro switch 31 into the dispenser 5 in such a way as to have the dispenser's activating paddle depress the switch to signal the state change when it is delivering cleaning agent. In another form, the specialized transceiver 6 may be activated by either an internal or external motion switch 32 that signals a state change upon sensing dispenser motion during the dispense event. Finally, when attached to an automated, powered dispenser the specialized transceiver 6 may receive the state change from the circuitry installed to govern the dispenser's operation.

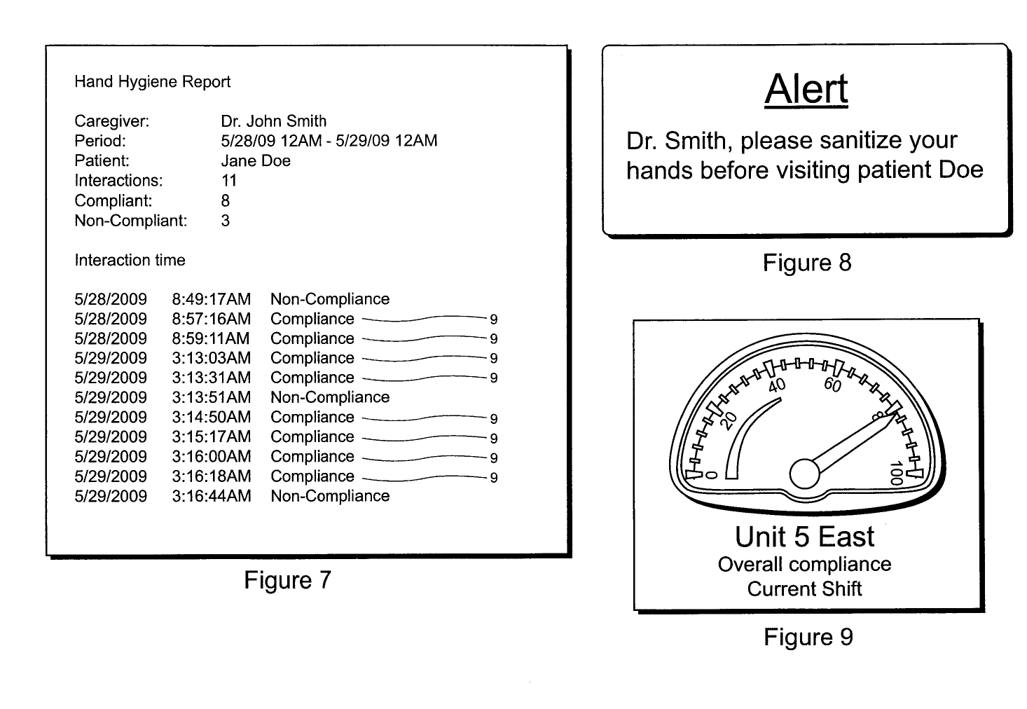

The tracking system 10 logs the status of the compliance event 9 (FIG. 7) associated with the modified badge signal 15 representative of the caregiver tag 33 as “compliant” and continues to monitor the unique ID received from the tag 12 for conditions that would relegate the caregiver tag 33 subject's status 9 from “compliant” to the default “non-compliant” state. Such conditions include (1) the passage of time, whereby after a predetermined interval, the status of the tag 12 (or the subject wearing the tag) is set to non-compliant or (2) the tag 12 is next detected by an IR receiver 20 in a zone wherein subjects are automatically designated “non-compliant”.

With regard to caregiver and patient interactions, a caregiver subject 33 having completed a hand hygiene event will interact with the patient subject 34 as one would expect. When a caregiver subject 33 interacts with a patient subject 34 the IDs of caregiver and patient tags 12, the time, the location and the compliance status 9 is recorded in an appropriate database.

Actions are taken in near real time to alert non-compliant caregivers of their status and reward status compliant caregivers. These actions typically consist of audio and/or visual alerts on a portable device carried by the caregiver, a nearby computer workstation or other appliance capable of status 9 notification.

An example of possible alerts are shown in FIGS. 8 and 9. FIG. 8 illustrates a text alert that can be sent to devices such as an alphanumeric pager carried by the caregiver or a computer workstation in the immediate vicinity of the caregiver. FIG. 9 illustrates a dashboard type indicator that can be displayed at the central nurse's station for any given care unit.

The database is subsequently mined for management reporting, a representative sample of which can be seen in FIG. 7. This report is used to reward conscientious caregivers or to counsel/change the behavior of less conscientious caregivers. The data can be used to compare infection rates for various diseases to actual hand hygiene compliance rates and aid root-cause analysis/research.

In summary, at least one embodiment of the present invention provides a method for determining hand hygiene compliance status within a tracking environment. The method includes providing a real-time locating tag, which emits infrared (IR) and radio frequency (RF) signals that are received by ceiling-mounted sensors, for each subject whose hand hygiene status must be known. The data associated with each tag includes the subject's ID and a default hygiene compliance status of “non-compliant”. The provision of this tag in a tracking environment allows the real-time tracking system to associate unique tag data with a particular location. The method further includes adding a battery-powered IR receiver and IR or RF transmitting device (i.e., transceiver) to each hand cleaning agent dispenser that, upon activation, scans the IR receiver spectrum in front of the dispenser for a valid real-time locating caregiver tag for a short, preset interval. If the IR receiver device detects a value ID from a real-time locating tag, then the IR receiver adds an identifying data element to the ID detected and received from the locating tag and retransmits the modified ID to the tracking system through an IR or RF signal.

At least one embodiment of the present invention also provides a system for real-time compliance or non-compliance notification and recording of hygiene status at the time of patient care. The system includes the aforementioned real-time locating tag in a tracking environment which also provides for the continual monitoring of the data record associated with each subject's unique ID tag. All interaction events among subjects with tag IDs possessing a hand hygiene status of either “compliant” or “non-compliant” and subjects with tag IDs identifying the subject as a patient will be recorded within the tracking system. Appropriate, predetermined actions will be initiated based on the “compliant” or “non-compliant” status of the former subject in relation to his location, time and/or interaction with a tag-wearing subject identified as a patient. The tracking environment, or the area in which sensors are available to receive tag ID data, can be programmed to delineate certain areas as “non-patient care” or “patient care” areas.

Hand hygiene status of tag-wearing subjects will be “non-compliant” as the default state. The default state changes to “compliant” only when the tag ID is detected by the receiver of the transceiver attached to the cleaning agent dispenser. The hand hygiene “compliant” status remains in effect until (1) sufficient time has passed according to a pre-set timeout or (2) the subject enters a predetermined “non-patient care” area. Tag-wearing subjects in a “non-compliant” state attempting to provide care to another tag-wearing subject (identified as a patient in the tracking system) will receive an alert designed to allow the tag-wearing subject (caregiver) to perform corrective action, or a hand hygiene event, prior to continuing interaction with the patient. Further, a tag-wearing subject possessing a hand hygiene “compliant” status in patient care areas will receive an alert if the time interval between the hand hygiene compliance event and patient care event exceeds the predetermined value.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A real-time method of monitoring hygiene compliance within a tracking environment provided by real-time tracking apparatus, wherein auto-ID personnel tags are associated with personnel whose hygiene compliance is desired to track locations of the personnel within the environment, each of the personnel tags being capable of transmitting a wireless signal including ID information unique to its associated personnel tag and wherein personnel location information is generated based on the locations of the personnel tags within the environment, the method comprising:
associating an auto-ID dispenser tag with each cleaning agent dispenser located within the tracking environment, each of the dispenser tags being capable of transmitting a wireless signal including ID information;
sensing a state change which indicates activation of a particular dispenser;
scanning a region about the activated dispenser for a first period of time in response to the state change to receive a wireless signal including its associated ID information transmitted by a personnel tag detected within the region;
utilizing the dispenser tag associated with the activated dispenser to transmit at least one wireless signal including information which identifies the detected personnel tag; and
assigning a status of hygiene compliant to the person associated with the detected personnel tag based on the signal transmitted by the dispenser tag.

2. The method as claimed in claim 1, wherein the environment is a clinical environment and the personnel are givers of care to patients and wherein an auto-ID patient tag is associated with each patient in the clinical environment to track locations of patients within the environment and wherein patient location information based on the locations of the patient tags within the environment is generated and wherein the method further comprises recording the caregiver and patient location information and the status of the caregivers.

3. The method as claimed in claim 1, further comprising assigning a status of hygiene non-compliant to the person associated with the detected personnel tag when either the detected personnel tag enters a hygiene non-compliant zone or a second period of time elapses following activation of the dispenser.

4. The method as claimed in claim 1, further comprising performing an action based on the status of the person.

5. The method as claimed in claim 4, wherein the action includes an audio or video alert.

6. The method as claimed in claim 5, wherein the alert is a video alert comprising a text or graphical alert.

7. The method as claimed in claim 1, wherein the step of scanning includes the step of scanning a delimited zone in front of the dispenser to detect the personnel tag.

8. The method as claimed in claim 1, wherein the hygiene is hand hygiene and the cleaning agent is a hand cleaning agent.

9. The method as claimed in claim 1, wherein the state change is a switch state change.

10. The method as claimed in claim 1, wherein the state change indicates motion or vibration associated with activation of the dispenser.

11. A real-time system for monitoring hygiene compliance within a tracking environment provided by a real-time tracking apparatus, wherein auto-ID personnel tags are associated with personnel whose hygiene compliance is desired to track locations of the personnel within the environment, each of the personnel tags being capable of transmitting a wireless signal including ID information unique to its associated personnel tag and wherein personnel location information is generated based on the locations of the personnel tags within the environment, the system comprising:
an auto-ID dispenser tag associated with each cleaning agent dispenser located within the tracking environment, each of the dispenser tags being capable of transmitting a wireless signal including ID information;
a dispenser sensor configured to sense state change which indicates activation of a particular dispenser located within the tracking environment;
a receiver associated with each of the dispensers and configured to scan a region about the activated dispenser for a first period of time in response to the state change and to receive a wireless signal including its associated ID information transmitted by a personnel tag detected within the region, the dispenser tag associated with the activated dispenser transmitting at least one wireless signal including information which identifies the detected personnel tag; and
means for assigning a status of hygiene complaint to the person associated with the detected personnel tag based on the signal transmitted by the dispenser tag.

12. The system as claimed in claim 11, wherein the environment is a clinical environment and the personnel are givers of care to patients and wherein an auto-ID patient tag is associated with each patient in the clinical environment to track locations of patients within the environment and wherein patient location information based on the locations of the patient tags within the environment is generated and wherein the caregiver and patient location information and the status of the caregivers are recorded in a data repository.

13. The system as claimed in claim 11, further comprising means for assigning a status of hygiene non-compliant to the person associated with the detected personnel tag when either the detected personnel tag enters a hygiene non-compliant zone or a second period of time elapses following activation of the dispenser.

14. The system as claimed in claim 11, further comprising means for performing an action based on the status of the person.

15. The system as claimed in claim 11, wherein the receiver scans a delimited zone in front of the dispenser to detect the personnel tag.

16. The system as claimed in claim 14, wherein the action includes an audio or video alert.

17. The system as claimed in claim 16, wherein the alert is a video alert comprising a text or graphical alert.

18. The system as claimed in claim 11, wherein the state change is a switch state change.

19. The system as claimed in claim 11, wherein the state change indicates motion or vibration associated with activation of the dispenser.

20. The system as claimed in claim 11, wherein the hygiene is hand hygiene and the cleaning agent is a hand cleaning agent.

21. The system as claimed in claim 11, wherein each of the dispenser tags includes a receiver and wherein each dispenser tag comprises a transceiver.
